(19) United States
(12) Patent Application Publication
(10) Pub. No.: US 2026/0158304 A1
(43) Pub. Date: Jun. 11, 2026

(54) FALL ARREST DEVICE WITH RING CONNECTED TO LOCKING TOOTH

(71) Applicant: YOKE INDUSTRIAL CORP., Taichung City (TW)

(72) Inventors: WEI-CHIEH HUNG, Taichung City (TW); CHIA-HSIEN WANG, Taichung City (TW); TZU-LUN WENG, Taichung City (TW)

(73) Assignee: YOKE INDUSTRIAL CORP., Taichung City (TW)

(21) Appl. No.: 18/969,292

(22) Filed: Dec. 5, 2024

(51) Int. Cl. A62B 35/00

(52) U.S. Cl. CPC A62B 35/0093; A62B 35/005

(57) ABSTRACT

A fall arrest device with a ring connected to a locking tooth is provided. A ring hole and a rope exit are provided on a top and a bottom of a casing. A ring of a ring assembly passes through the ring hole. A bottom end of the ring is engaged with a ring seat. The ring seat is fitted into the top of the casing and is connected to a locking tooth. A main shaft and a rotating drum rotatably fitted around the main shaft are fixed in the casing. A spiral spring is connected between the rotating drum and the main shaft. A rope is wound around the rotating drum to have a plurality of turns and extends from casing through the ring hole. A mounting portion on a side of the rotating drum is engaged with a braking assembly configured to engage with the locking tooth.

### BACKGROUND OF THE INVENTION

### Technical Field

The present invention relates generally to a safety apparatus, and more particularly to a fall arrest device with a ring connected to a locking tooth.

### Description of Related Art

A conventional fall arrest device is to fix a main shaft in a casing. A rotating drum and a ratchet gear are rotatably engaged with the main shaft. A side of the rotating drum is engaged with a braking assembly. A rope is wound onto the rotating drum to have a plurality of turns and is engaged around the rotating drum.

When the conventional fall arrest device is used, the casing is fixed to a place, and an end of the rope passing out of the casing is engaged with a wearable harness on a user. When the user wearing the wearable harness falls from height, the rotating drum in the fall arrest device rotates quickly by pulling the rope, so that the braking assembly engaged with the rotating drum changes from a state of engaging with the ratchet gear to a state of engaging with the ratchet gear due to a centrifugal force of during quick rotation. When the braking assembly is engaged with the ratchet gear, the braking assembly stops the rotating drum from continuously rotating and releasing the rope, so that the user could be prevent from continuously falling, thereby ensuring the safety.

The conventional fall arrest device could prevent the user from continuously falling. However, as the ratchet and the rotating drum in the fall arrest device are fixed on the main shaft of the casing, a length of the main shaft and a volume of the casing could not be reduced, so that a size of the fall arrest device could not be effectively reduced.

### BRIEF SUMMARY OF THE INVENTION

In view of the above, the primary objective of the present invention is to re-design a structure which is configured to engage with a braking assembly located adjacent to the rotating drum, so that the structure inside a fall arrest device is simplified, thereby reducing a size of the fall arrest device and a production cost.

The present invention provides a fall arrest device with a ring connected to a locking tooth, including a casing, a ring assembly, and a main body. A top of the casing has a ring hole. A bottom of the casing has a rope exit. A mounting space is provided in the casing. The mounting space communicates with the rope exit and the ring hole. A part of the casing adjacent to an inner side of the ring hole forms a ring seat groove. The ring assembly includes a ring seat, a locking tooth, and a ring. The ring seat is fitted into the ring seat groove. The locking tooth is connected to a side of the ring seat. A middle of the ring passes through the ring hole and an inner end of the ring is engaged with the ring seat. The main body includes a main shaft, a rotating drum, a spiral spring, a rope, and a braking assembly. The main shaft is fixed in the mounting space. The rotating drum is rotatably fitted around the main shaft. A side of the rotating drum has a mounting portion. A spiral spring cavity is provided in the rotating drum. The spiral spring is disposed in the spiral spring cavity and is connected between the main shaft and the rotating drum. An end of the rope is engaged with the rotating drum and is wound around the rotating drum to have a plurality of turns. Another end of the rope extends out of the rope exit. The braking assembly is engaged with the mounting portion and is configured to engage with the locking tooth.

With the aforementioned design, as the locking tooth is disposed on the ring seat of a bottom of the ring assembly, the locking tooth is disposed on a top side of the mounting space, and the locking tooth is configured to engage with the braking assembly engaged with a side of the rotating drum for braking the rotating drum and the rope released from the rotating drum. In this way, the fall arrest device with the ring connected to the locking tooth could be provided without having a ratchet gear or a braking structure similar to the ratchet gear, which is configured to engage with the braking assembly, on the periphery of the main shaft or an inner side of the casing, so that a length of the main shaft and a size of the casing in an extension direction of the main shaft could be reduced. Therefore, the present invention could reduce a size of the fall arrest device with the ring connected to the locking tooth. Moreover, the rotating drum and the braking assembly are provided around the main shaft, so that the structure inside the casing could be simplified, thereby reducing a production cost.

### BRIEF DESCRIPTION OF THE SEVERAL VIEWS OF THE DRAWINGS

The present invention will be best understood by referring to the following detailed description of some illustrative embodiments in conjunction with the accompanying drawings, in which

FIG. 1 is a perspective view of the fall arrest device according to an embodiment of the present invention;

FIG. 2 is an exploded view of the fall arrest device according to the embodiment of the present invention;

FIG. 3 is a perspective view, showing that the rotating drum and the braking assembly in FIG. 2 are separated;

FIG. 4 is a left side view of the fall arrest device according to the embodiment of the present invention;

FIG. 5 is a sectional view along the 5-5 line in FIG. 4;

FIG. 6 is a front view of the fall arrest device according to the embodiment of the present invention;

FIG. 7 is a sectional view along the 7-7 line in FIG. 6;

FIG. 8 is a sectional view along the 8-8 line in FIG. 6; and

FIG. 9 is a schematic view, showing that the ratchet block on the top in FIG. 8 is engaged with the locking tooth.

### DETAILED DESCRIPTION OF THE INVENTION

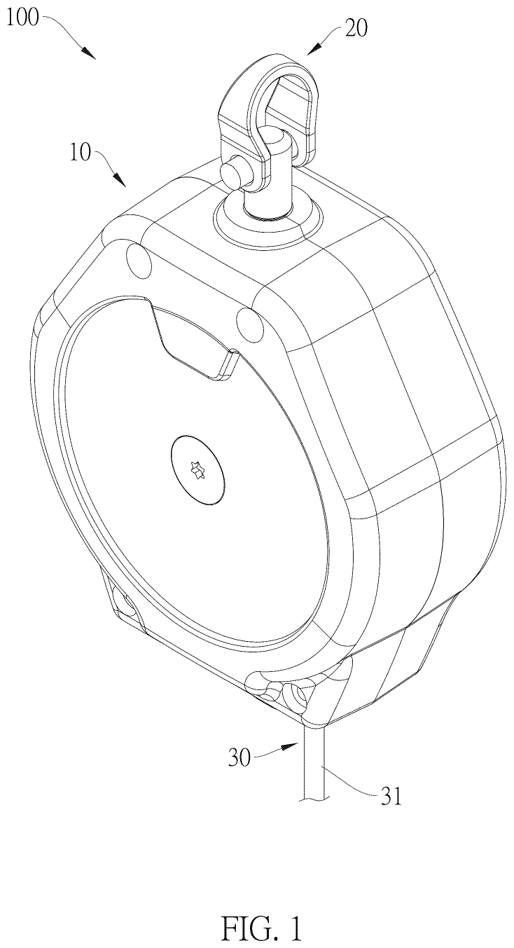

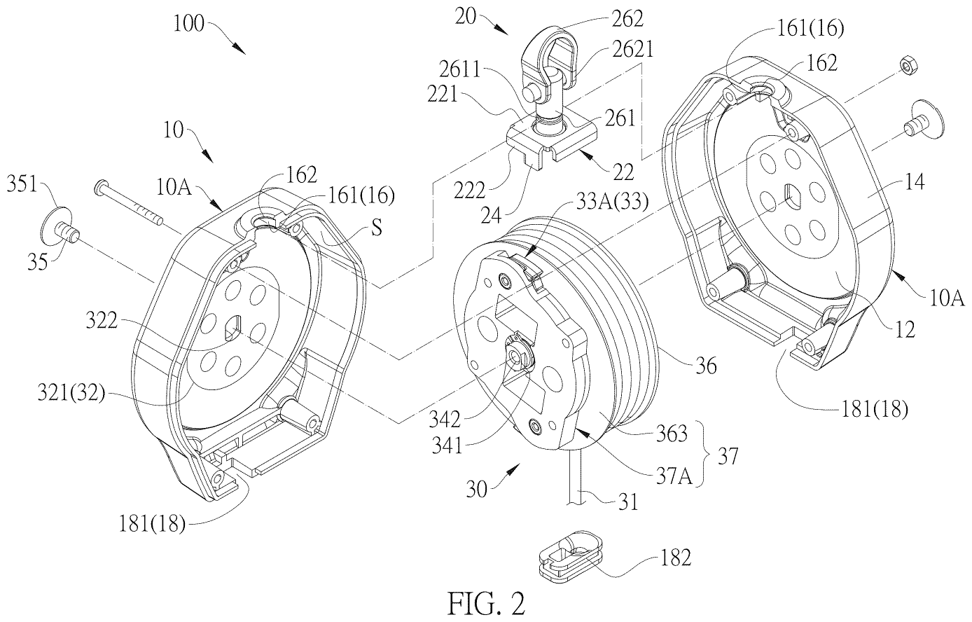

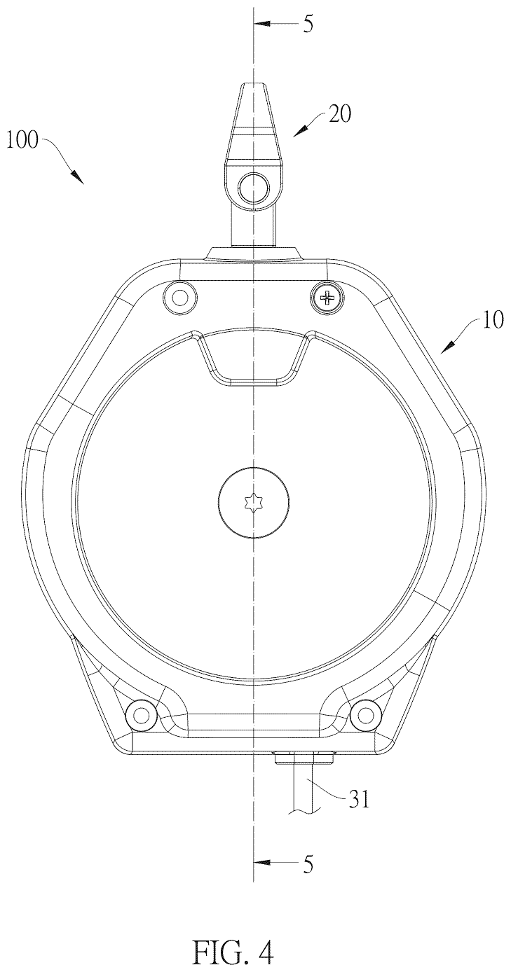

A fall arrest device 100 with a ring connected to a locking tooth according to an embodiment of the present invention is illustrated in FIG. 1 to FIG. 5 and includes a casing 10, a ring assembly 20, and a main body 30. The ring assembly 20 is engaged with the casing 10. The main body 30 is mounted in the casing 10. As the casing 10 and the main body 30 are hanged on a place by the ring assembly 20, two opposite sides of the casing 10 in a top-bottom direction are defined as a top side and a bottom side, respectively, and the terminology used therein is for the purpose of describing particular embodiments in the description below.

The casing 10 includes two half casings 10A. A mounting space S is provided in the casing 10. The two half casings 10A are engaged with each other by screwing, so that the two half casings 10A are detachable relative to each other. In other embodiments, the two half casings 10A could be engaged by hooking or tenoning. Each of the half casings 10A has a side wall 12 and a peripheral wall 14 connected to the side wall 12. The two side walls 12 of the two half casings 10A face each other. A peripheral edge of a top side of the peripheral wall 14 of each of the half casings 10A forms a ring recess 161. The two ring recesses 161 of the two half casings 10A are semi-circular and are joined to form a ring hole 16. The ring hole 16 communicates with the mounting space S. A peripheral edge of the ring hole 16 has a positioning protrusion 162. A part of the casing 10 located on a top of the mounting space S and adjacent to an inner side of the ring hole 16 forms a ring seat groove 163. A peripheral edge of a bottom side of the peripheral wall 14 of each of the half casings 10A forms a rope recess 181. The two rope recesses 181 of the two half casings 10A are joined to form a rope exit 18. The rope exit 18 communicates with the mounting space S. A guiding ring 182 is fixed on a peripheral edge of the rope exit 18.

The ring assembly 20 includes a ring seat 22, a locking tooth 24, and a ring 26. The ring seat 22 is fitted into the ring seat groove 163 of the casing 10. The ring seat 22 has a top plate 221 and a surrounding plate 222 connected to a periphery of the top plate 221. A middle of the top plate 221 has a ring seat hole 223. The ring seat hole 223 is located directly below the ring hole 16. The locking tooth 24 is a pawl and is connected to a side of the ring seat 22. More specifically, the locking tooth 24 is connected to a side of the surrounding plate 222.

The ring 26 includes a rod portion 261, a ring portion 262, and a pin 263. The rod portion 261 passes through the ring hole 16. A positioning groove 2611 is provided around the rod portion 261. The positioning protrusion 162 around the ring hole 16 is fitted into the positioning groove 2611, thereby fixing a position of the rod portion 261. A bottom end of the rod portion 261 passes through the ring seat hole 223 of the ring seat 22. A hanging protrusion 2612 is formed around the bottom end of the rod portion 261. The hanging protrusion 2612 abuts against a peripheral edge of a bottom end of the ring seat hole 223. An inner pin hole 2613 laterally penetrates through a top end of the rod portion 261. The ring portion 262 is C-shaped. Two lugs 2621 are provided on two sides of the ring portion 262, respectively. Two outer pin holes 2622 pass through the two lugs 2621, respectively. The pin 263 passes through the two outer pin holes 2622 and the inner pin hole 2613 for fixing.

The main body 30 includes a frame 32, a main shaft 34, a rotating drum 36, a spiral spring 38, a rope 31, and a braking assembly 33. The frame 32 includes two plate bodies 321. Each of the plate bodies 321 is a plate that is hollowed out around the plate. Each of the plate bodies 321 is embedded on a middle of the side wall 12 of each of the half casings 10A by insert molding. A center of each of the plate bodies 321 has a through hole 322. The through hole 322 of each of the plate bodies 321 penetrates through the side wall 12 of each of the half casings 10A. The two through holes 322 of the two plate bodies 321 are non-circular holes. In other embodiments, one of the two through holes 322 is non-circular while the other through hole 322 could be changed to other shapes.

A direction in which an axial line of the main shaft 34 extends is defined as an axial direction L. The axial direction L is perpendicular to the top-bottom direction. Two end portions 341 are formed on two ends of the main shaft 34, respectively. A shape of a periphery of each of the end portions 341 matches with a shape of one of the two through holes 322 of the two plate bodies 321 that is corresponding. Each of the end portions 341 is fitted into the through hole 322 of each of the plate bodies 321. An outer end of each of the end portion 341 has a screw hole 342. Two fixing screws 35 are screwed into the two screw holes 342 of the two end portions 341, respectively. Each of the fixing screws 35 has a head portion 351. The head portion 351 of each of the fixing screws 35 abuts against a peripheral edge of the through hole 322 of each of the plate bodies 321, so that the main shaft 34 is fixed in the mounting space S of the casing 10, and the main shaft 34 is not rotatable relative to the casing 10.

The rotating drum 36 is rotatably fitted around the main shaft 34. A rope groove 361 is provided around the rotating drum 36. A spiral spring cavity 362 is provided in the rotating drum 36. One of two sides of rotating drum 36 in the axial direction L has a mounting portion 37. The mounting portion 37 includes a mounting surface 363 and a fixed plate 37A engaged with the mounting surface 363 by screwing. A middle of the mounting surface 363 has a fitting groove 364. An inner surface of the fitting groove 364 has a restricting block 365. The fixed plate 37A has an outer plate 371 and an inner plate 372 that are connected in sequence along the axial direction L. The inner plate 372 is coaxially connected to a middle of the outer plate 371. The inner plate 372 is fitted into the fitting groove 364 and has a restricting groove 3721. The restricting groove 3721 is fitted around the restricting block 365 for fixing. A center of the fixed plate 37A has an axial hole 371A. The axial hole 371A penetrates a center of the outer plate 371 and a center of the inner plate 372 and is rotatably fitted around the main shaft 34.

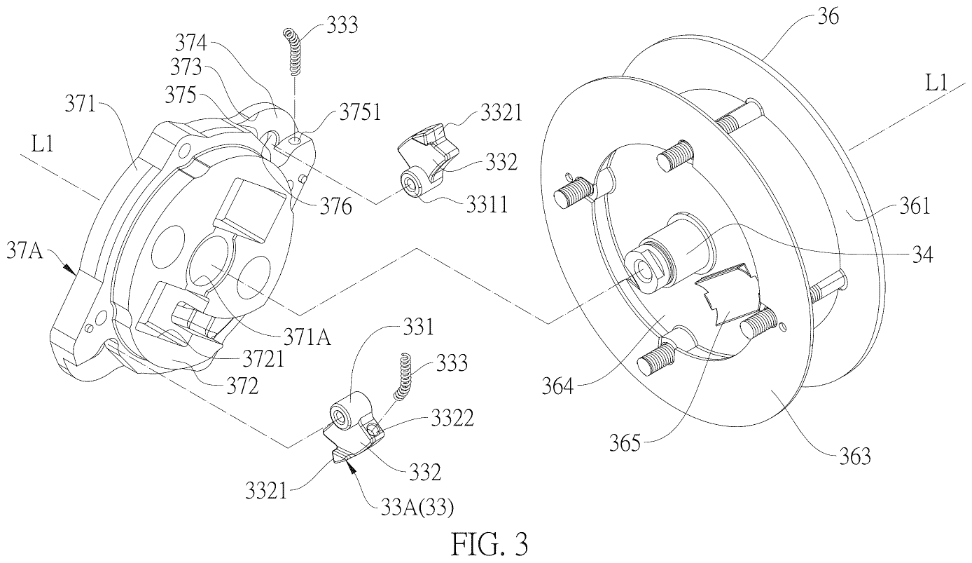

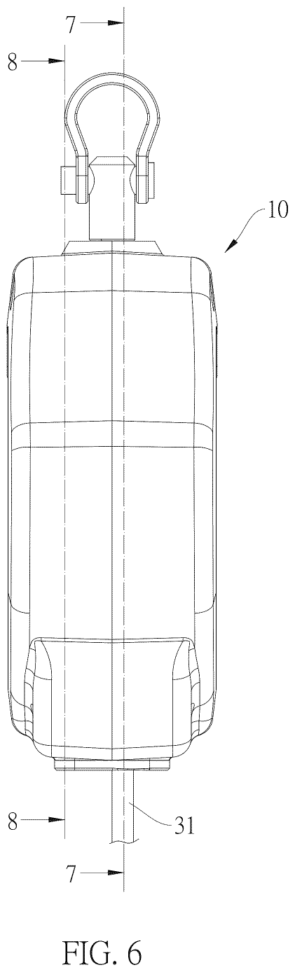

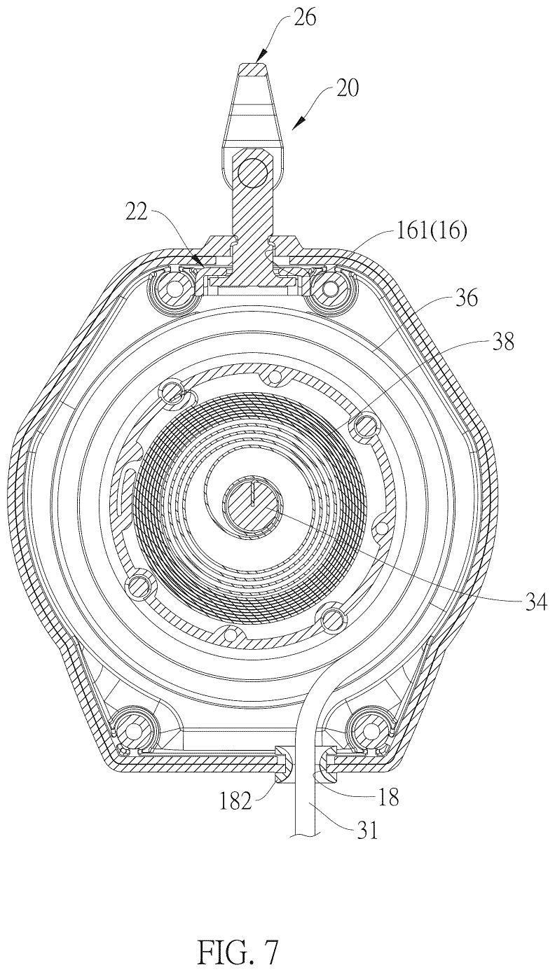

Referring to FIG. 3 and FIG. 5 to FIG. 8, two ratchet grooves 373 are formed on a periphery of the outer plate 371 of the fixed plate 37A and are arranged by an interval around the fixed plate 37A. In the current embodiment, the two ratchet grooves 373 are located on two opposite sides of the periphery of the main shaft 34, respectively. One of two sides of each of the ratchet grooves 373 in the axial direction L is adjacent to the mounting surface 363, and the other side of each of the ratchet grooves 373 in the axial direction L has a side wall 374. A side of an inner side of each of the ratchet grooves 373 forms an inner wall 375, and another side of the inner side of each of the ratchet grooves 373 forms a spring groove 3751. The side wall 374 of each of the ratchet grooves 373 has a rotation shaft hole 376. The rotation shaft hole 376 of each of the ratchet grooves 373 is located between the inner wall 375 of each of the ratchet grooves 373 and the spring groove 3751 of each of the ratchet grooves 373. The rotation shaft hole 376 of each of the ratchet grooves 373 is adjacent to the inner wall 375 of each of the ratchet grooves 373.

The spiral spring 38 is disposed in the spiral spring cavity 362. The spiral spring 38 has two ends, wherein one of the two ends of the spiral spring 38 is engaged with the main shaft 34, and the other end of the spiral spring 38 is engaged with the rotating drum 36. In this way, after the rotating drum 36 rotates relative to the main shaft 34, the spiral spring 38 provides a restoring force for the rotating drum 36 to rotate and restore an original position. The rope 31 has two ends, wherein one of the two ends of the rope 31 is engaged with the rotating drum 36. The rope 31 is received in the rope groove 361 and is wound around the rotating drum 36 to have a plurality of turns. The other end of the rope 361 passes through an inner side of the guiding ring 182 to extend out of the rope exit 18 of the casing 10. When the rope 31 is pulled outwards from the rope exit 18 by an external force, the rope 31 drives the rotating drum 36 to rotate around the main shaft 34, wherein a rotation direction of the rotating drum 36 at that time is defined as a forward direction (i.e., the rotating drum 36 performs a forward rotation). On the contrast, when the external force pulling the rope 31 outwards is removed, the spiral spring 38 provides the restoring force for the rotating frum 36 to rotate and restore to the original position, wherein at that time, the rotating drum 36 performs a reverse rotation (i.e., the rotation direction of the rotating drum 36 is defined as a reverse direction) and rewinds the rope 31, which has been released outwards, into the casing 10.

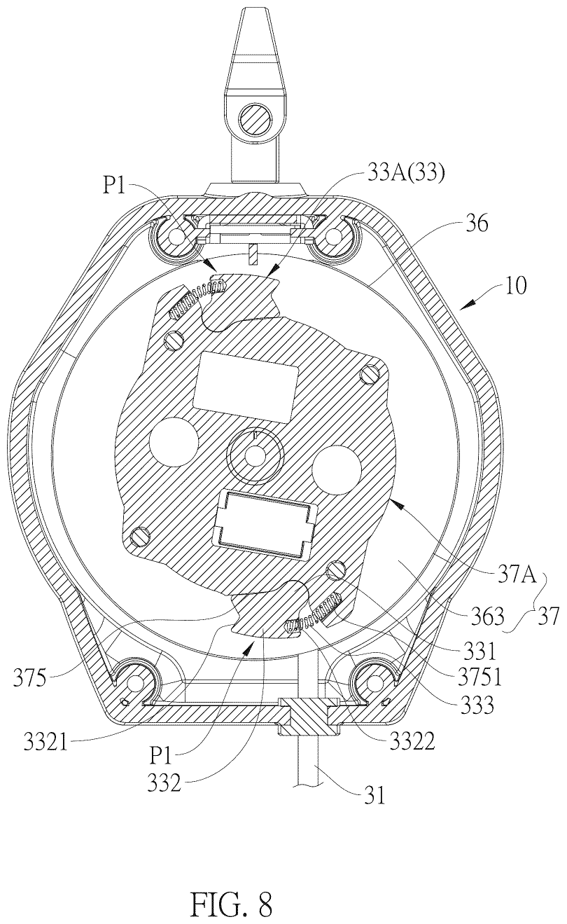

The braking assembly 33 includes a plurality of ratchet blocks 33A, wherein a number of the ratchet blocks 33A is equal to a number of the ratchet grooves 373. In the current embodiment, the braking assembly 33 includes two ratchet blocks 33A. Each of the ratchet blocks 33A is received in each of the ratchet grooves 373. Each of the ratchet blocks 33A includes a base portion 331 and a body portion 332 that are connected to each other. The base portion 331 of each of the ratchet blocks 33A has a rotation shaft 3311. The rotation shaft 3311 of each of the ratchet blocks 33A rotatably passes through the rotation shaft hole 376 of each of the ratchet grooves 373. The body portion 332 of each of the ratchet blocks 33A abuts against the inner wall 375 of each of the ratchet grooves 373. A ratchet 3321 and a spring recess 3322 are respectively formed on two sides of the body portion 332 of each of the ratchet blocks 33A, wherein the two sides of the body portion 332 of each of the ratchet blocks 33A correspond to the forward rotation and the reverse rotation of the rotating drum 36, respectively. Referring to FIG. 3 and FIG. 8, a restoring spring 333 is disposed between the spring recess 3322 of each of the ratchet blocks 33A and the spring groove 3751 of each of the ratchet grooves 373 in a compressible manner. The two restoring springs 333 are configured to maintain the two ratchet blocks 33A at the first position P1, i.e., the body portion 332 of each of the ratchet blocks 33A abuts against the inner wall 375 of each of the ratchet grooves 373.

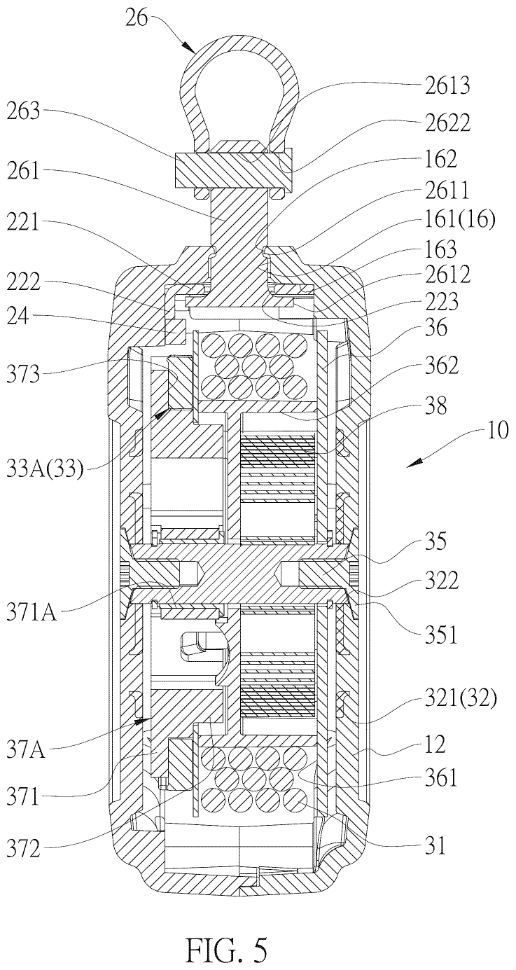

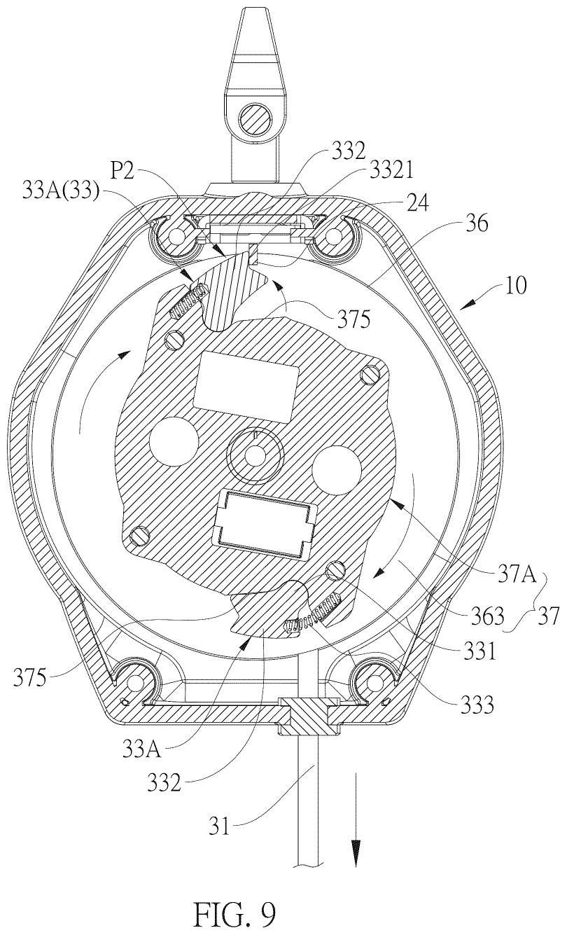

Referring to FIG. 5 and FIG. 7 to FIG. 9, when the rope 31 is pulled outward by the external force and drives the rotating drum 36 to perform the forward rotation and a rotation speed of the ratchet blocks 33A of the braking assembly 33 is greater than a predetermined rotation speed as the rotating drum 36 rotates, a centrifugal force acting on each of the ratchet blocks 33A is greater than an elastic force of the restoring spring 333, which is caused by a compression of the restoring spring 333, acting on each of the ratchet blocks 33A, so that each of the ratchet blocks 33A rotates outwards to a second position P2 around the rotation shaft 3311 of each of the ratchet blocks 33A. When each of the ratchet blocks 33A is located at the second position P2, the body portion 332 of each of the ratchet blocks 33A rotates outwards from the inner wall 375 of each of the ratchet grooves 373 and the ratchet 3321 of each of the ratchet blocks 33A extends out from each of the ratchet grooves 373. At that time, a moving path of the ratchets 3321 of each of the ratchet blocks 33A during the rotation of the rotating drum 36 interferes with a position of the locking tooth 24, so that the ratchet 3321 of one of the ratchet blocks 33A, which rotates to a top, is engaged with the locking tooth 24, thereby immediately stopping the rotating drum 36 from rotating. When the rotating drum 36 stops rotating, the rotating drum 36 stops releasing the rope 31 outwards. At that time, the other ratchet block 33A, which is located on a bottom, is pushed by the corresponding restoring spring 333 to restore from the second position P2 to the first position P1.

A value of the predetermined rotation speed of the ratchet blocks 33A to rotate from the first position P1 to the second position P2 is set in correspondence with a practical scenario that the casing 10 of the present invention is hanged on a fixed place by the ring 26 and the other end of the rope 31 extending out of the rope exit 18 is engaged with a wearable harness of a user. The value of the predetermined rotation speed is typically set to be greater than a rotation speed of a rotation of the rotating drum 36 caused by pulling the rope 31 outwards from the rope exit 18 with hands or a movement of the user. The value of the predetermined rotation speed is set to be less than a rotation speed of a rotation of the rotating drum 36 caused by pulling the rope 31 outwards due to the user falling from height. In this way, the fall arrest device 100 with the ring connected to the locking tooth of the present invention could prevent the user from continuously falling when the user falls from height; at a normal state, the rope 31 could be pulled outwards by the hands or the movement of the user and could be rewound onto the rotating drum 36 when the rope 31 is stopped from being pulled, so that the movement of the user during working would not be obstructed.

With the aforementioned design, as the locking tooth 24 is disposed on the ring seat 22 of a bottom of the ring assembly 20, the locking tooth 24 is disposed on a top side of the mounting space S and is located above the braking assembly 33, and the locking tooth 24 is configured to engage with the braking assembly 33 engaged with a side of the rotating drum 36 for braking the rotating drum 36. In this way, the fall arrest device 100 with the ring connected to the locking tooth could be provided without having a ratchet gear or a braking structure similar to the ratchet gear, which is configured to engage with the braking assembly 33, on the periphery of the main shaft 34 or an inner side of the casing. In comparison with a structure with a ratchet gear disposed on the main shaft 34, the fall arrest device 100 with the ring connected to the locking tooth could reduce a length of the main shaft 34 and a size of the casing 10 in the axial direction L. Therefore, the present invention could reduce a size of the fall arrest device 100 with the ring connected to the locking tooth and reduce a production cost by simplifying the inner structure of the fall arrest device 100 with the ring connected to the locking tooth.

In the embodiment, the two ratchet grooves 373 are formed on the periphery of the fixed plate 37A and are arranged by an interval, and the two ratchet blocks 33A are disposed on the two ratchet grooves 373. In other embodiments, three or more ratchet grooves 373 could be formed on the periphery of the fixed plate 37A and be arranged by intervals, and three or more ratchet blocks 33A of the braking assembly 33 could be disposed on the ratchet grooves 373.

It must be pointed out that the embodiments described above are only some preferred embodiments of the present invention. All equivalent structures which employ the concepts disclosed in this specification and the appended claims should fall within the scope of the present invention.

What is claimed is:

1. A fall arrest device with a ring connected to a locking tooth, comprising:
a casing, wherein a top of the casing has a ring hole; a bottom of the casing has a rope exit; a mounting space is provided in the casing; the mounting space communicates with the rope exit and the ring hole; a part of the casing adjacent to an inner side of the ring hole forms a ring seat groove;
a ring assembly, comprising a ring seat, a locking tooth, and a ring, wherein the ring seat is fitted into the ring seat groove; the locking tooth is connected to a side of the ring seat; a middle of the ring passes through the ring hole and an inner end of the ring is engaged with the ring seat;
a main body, comprising a main shaft, a rotating drum, a spiral spring, a rope, and a braking assembly, wherein the main shaft is fixed in the mounting space; the rotating drum is rotatably fitted around the main shaft; a side of the rotating drum has a mounting portion; a spiral spring cavity is provided in the rotating drum; the spiral spring is disposed in the spiral spring cavity and is connected between the main shaft and the rotating drum; an end of the rope is engaged with the rotating drum and is wound around the rotating drum to have a plurality of turns; another end of the rope extends out of the rope exit; the braking assembly is engaged with the mounting portion and is configured to engage with the locking tooth.

2. The fall arrest device as claimed in claim 1, wherein a peripheral edge of the ring hole has a positioning protrusion; the ring has a rod portion and a ring portion; a positioning groove is provided around the rod portion; the positioning protrusion is fitted into the positioning groove for fixing; an inner pin hole laterally penetrates through a top end of the rod portion; two lugs are provided on two sides of the ring portion, respectively; two outer pin holes are provided on the two lugs, respectively; a pin passes through the two outer pin holes and the inner pin hole for fixing.

3. The fall arrest device as claimed in claim 2, wherein the ring seat has a top plate and a surrounding plate connected to a periphery of the top plate; a middle of the top plate has a ring seat hole; a bottom end of the rod portion passes through the ring seat hole; a hanging protrusion is formed around the bottom end of the rod portion; the hanging protrusion abuts against a peripheral edge of a bottom end of the ring seat hole.

4. The fall arrest device as claimed in claim 3, wherein the casing comprises two half casings; the two half casings are detachably engaged with each other; a top side of each of the two half casings has a ring recess; the two ring recesses of the two half casings are joined to form the ring hole; a bottom side of each of the two half casings has a rope recess; the two rope recesses of the two half casings are joined to form the rope exit.

5. The fall arrest device as claimed in claim 4, wherein each of the two half casings has a side wall and a peripheral wall connected to the side wall of each of the two half casings; the ring recess of each of the two half casings is formed on a peripheral edge of a top side of the peripheral wall of each of the two half casings; the rope recess of each of the two half casings is formed on a peripheral edge of a bottom side of the peripheral wall of each of the two half casings.

6. The fall arrest device as claimed in claim 5, wherein the main body comprises a frame; the frame comprises two plate bodies; each of the two plate bodies is embedded on a middle of the side wall of each of the two half casings and has a through hole; at least one of the two through holes of the two plate bodies is a non-circular hole; two end portions are formed on two ends of the main shaft, respectively; each of the two end portions is fitted into the through hole of each of the two plate bodies and has a screw hole; two fixing screws are screwed into the two screw holes of the two end portions, respectively; each of the two fixing screws has a head portion; the head portion of each of the two fixing screws abuts against a peripheral edge of the through hole of each of the two plate bodies for fixing.

7. The fall arrest device as claimed in claim 1, wherein the braking assembly comprises a plurality of ratchet blocks; each of the plurality of ratchet blocks comprises a base portion and a body portion that are connected to each other; the plurality of ratchet blocks are arranged by intervals around the mounting portion and are pivotally connected to a periphery of the mounting portion by the plurality of base portions of the plurality of ratchet blocks; the body portion of each of the plurality of ratchet blocks has a ratchet; a plurality of restoring springs is provided; each of the plurality of restoring springs is disposed between each of the plurality of ratchet blocks and the mounting portion; each of the plurality of restoring springs is configured to maintain each of the plurality of ratchet blocks at a first position; when a rotation speed of the plurality of ratchet blocks is greater than a predetermined rotation speed as the rotating drum rotates, each of the plurality of ratchet blocks rotates outwards to a second position due to a centrifugal force; when each of the plurality of ratchet blocks is located at the second position, a moving path of the ratchet of each of the plurality of ratchet blocks during a rotation of the rotating drum interferes with a position of the locking tooth, so that the ratchet of one of the plurality of ratchet blocks is engaged with the locking tooth.

8. The fall arrest device as claimed in claim 7, wherein the main shaft has an axial direction; the mounting portion comprises a mounting surface and a fixed plated engaged with the mounting surface; a center of the fixed plate has an axial hole; the axial hole is rotatably fitted around the main shaft; a plurality of ratchet grooves is formed on a periphery of the fixed plate and is arranged by intervals around the fixed plate; a side of an inner side of each of the plurality of ratchet grooves forms an inner wall, and another side of the inner side of each of the plurality of ratchet grooves forms a spring groove; one of two sides of each of the plurality of ratchet grooves in the axial direction is adjacent to the mounting surface, and the other side of each of the plurality of ratchet grooves in the axial direction has a side wall; the side wall of each of the plurality of ratchet grooves has a rotation shaft hole; the rotation shaft hole is located between the inner wall and the spring groove; each of the plurality of ratchet blocks is received in each of the plurality of ratchet grooves; the base portion of each of the plurality of ratchet blocks has a rotation shaft; the rotation shaft rotatably passes through the rotation shaft hole; the ratchet of each of the plurality of ratchet blocks is formed on a side of the body portion of each of the plurality of ratchet blocks, and a spring recess is formed on another side of the body portion of each of the plurality of ratchet blocks; each of the plurality of restoring springs is disposed between the spring recess of each of the plurality of ratchet blocks and the spring groove of each of the plurality of ratchet grooves in a compressible manner; when each of the plurality of ratchet blocks is located at the first position, the body portion of each of the plurality of ratchet blocks abuts against the inner wall of each of the plurality of ratchet grooves; when each of the plurality of ratchet blocks is located at the second position, the body portion of each of the plurality of ratchet blocks rotates outwards from the inner wall of each of the plurality of ratchet grooves and the ratchet of each of the plurality of ratchet blocks extends out from each of the plurality of ratchet grooves.

9. The fall arrest device as claimed in claim 8, wherein a middle of the mounting surface has a fitting groove; the fixed plate has an outer plate; the plurality of the ratchet grooves are formed on a periphery of the outer plate; a middle of the outer plate is connected to an inner plate; the inner plate is fitted into the fitting groove.

10. The fall arrest device as claimed in claim 9, wherein an inner surface of the fitting groove has a restricting block; the inner plate has a restricting groove; the restricting groove is fitted around the restricting block for fixing.
